(19) United States
(12) Patent Application Publication
(10) Pub. No.: US 2026/0243209 A1
(43) Pub. Date: Aug. 20, 2026

(54) CONTROL APPARATUS FOR INTERNAL COMBUSTION ENGINE

(71) Applicant: Honda Motor Co., Ltd., Tokyo (JP)

(72) Inventors: Ken Matsui, Tokyo (JP); Toshiyuki Nakamura, Tokyo (JP); Toshiaki Ichoda, Tokyo (JP)

(21) Appl. No.: 19/536,091

(22) Filed: Feb. 10, 2026

(30) Foreign Application Priority Data
Feb. 14, 2025 (JP) 2025-022013

(51) Int. Cl. F02D 41/02; F02D 41/12

(52) U.S. Cl. CPC F02D 41/024; F02D 41/025; F02D 41/0255; F02D 41/029; F02D 41/126

(57) ABSTRACT

A control apparatus for an internal combustion engine including an intake adjustment part configured to adjust an intake air amount sucked into the internal combustion engine, and an electronic control unit including a microprocessor and a memory connected to the microprocessor. The microprocessor is configured to perform acquiring information on a catalyst temperature in an exhaust gas purification device provided in an exhaust passage of the internal combustion engine, controlling the intake adjustment part in accordance with a load, and the controlling including restricting the intake air amount in accordance with the catalyst temperature so as to start a restriction on the intake air amount earlier as a degree of increase in the catalyst temperature becomes greater.

### CROSS-REFERENCE TO RELATED APPLICATION

This application is based upon and claims the benefit of priority from Japanese Patent Application No. 2025-022013 filed on February 14, 2025, the content of which is incorporated herein by reference.

### BACKGROUND OF THE INVENTION

### Field of the Invention

This invention relates to a control apparatus for an internal combustion engine.

### Description of the Related Art

In recent years, efforts aimed at mitigating or reducing the impacts of climate change have continued, and research and development has been conducted to improve emissions towards this achievement. As a technology for this kind of apparatus, conventionally, when an internal combustion engine is operated under high-load conditions with high exhaust gas temperatures, an apparatus is known in which fuel is enriched and injected to protect the catalyst. Such an apparatus is described in, for example, Japanese Unexamined Patent Publication No. 1998-002216 (JPH10-002216A). In the device described in JPH10-002216A, if fuel enrichment alone is insufficient to reduce the exhaust temperature, the amount of air sucked into the internal combustion engine is reduced.

However, a delay in the reduction of the amount of air sucked into the internal combustion engine may cause the exhaust temperature to overshoot, potentially damaging the catalyst, and measures are needed for this.

### SUMMARY OF THE INVENTION

An aspect of the present invention is a control apparatus for an internal combustion engine including an intake adjustment part configured to adjust an intake air amount sucked into the internal combustion engine, and an electronic control unit including a microprocessor and a memory connected to the microprocessor. The microprocessor is configured to perform acquiring information on a catalyst temperature in an exhaust gas purification device provided in an exhaust passage of the internal combustion engine, and controlling the intake adjustment part in accordance with a load, the controlling including restricting the intake air amount in accordance with the catalyst temperature so as to start a restriction on the intake air amount earlier as a degree of increase in the catalyst temperature becomes greater.

### BRIEF DESCRIPTION OF THE DRAWINGS

The objects, features, and advantages of the present invention will become clearer from the following description of embodiments in relation to the attached drawings, in which:

FIG. 1 is a diagram schematically illustrating a configuration of a main part of an engine to which a control apparatus for an internal combustion engine according to an embodiment of the present invention is applied;

FIG. 2 is a block diagram illustrating a configuration of a main part of the control apparatus for the internal combustion engine according to the embodiment of the present invention;

FIG. 3A is a diagram illustrating a relationship between a load acting on the engine and an estimated temperature which is an estimated value of the catalyst temperature;

FIG. 3B is a diagram illustrating a relationship between the estimated temperature and set values for start and end of an intake control;

FIG. 4 is a time chart illustrating an example of changes of the catalyst temperature and the estimated temperature with a lapse of time;

FIG. 5 is a flowchart illustrating an example of processing executed by a controller in FIG. 2;

FIG. 6 is a time chart illustrating an example of changes in the catalyst temperature and an intake air amount; and

FIG. 7 is a diagram illustrating an example of calculating the catalyst temperature based on the estimated temperature.

### DETAILED DESCRIPTION OF THE INVENTION

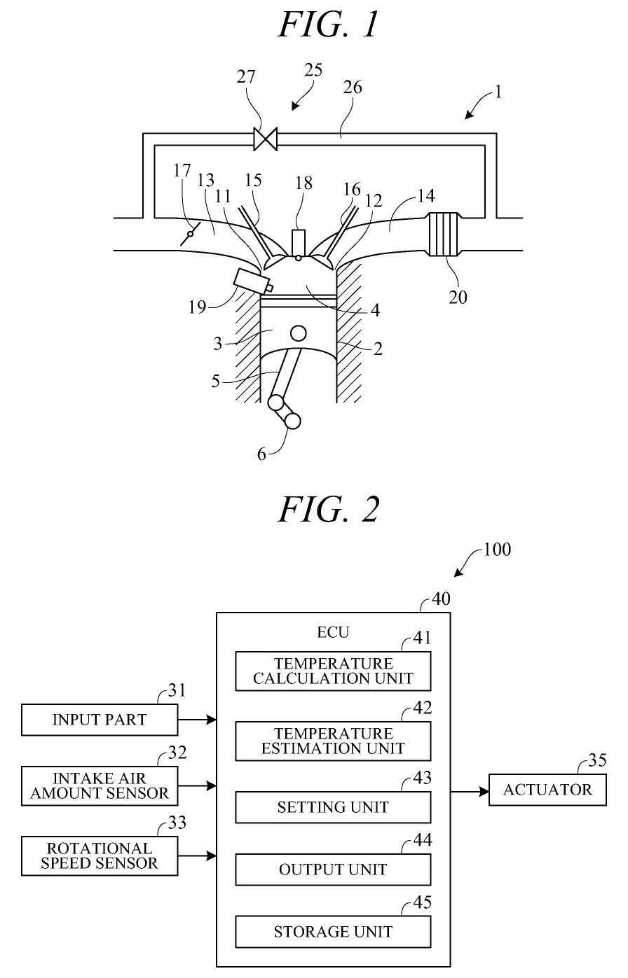

Hereinafter, an embodiment of the present invention will be described below with reference to FIGS. 1 to 7. A control apparatus for an internal combustion engine according to an embodiment of the present invention is applied to a vehicle equipped with a gasoline engine as an internal combustion engine. That is, the present invention is applied to an engine vehicle that travels using only an engine as a driving source and a hybrid vehicle that travels using an engine and a motor as driving sources.

FIG. 1 is a diagram schematically illustrating a configuration of a main part of an engine 1 which is an internal combustion engine to which a control apparatus according to the present embodiment is applied. The engine 1 is a spark ignition type internal combustion engine that ignites a mixture of fuel and air supplied into a combustion chamber to obtain power, and is a four-stroke engine that undergoes four strokes of intake, compression, expansion, and exhaust during an operation cycle. The engine 1 includes a plurality of cylinders having the same configuration. FIG. 1 illustrates a configuration of a single cylinder.

As illustrated in FIG. 1, the engine 1 includes a cylinder 2 that is formed in a cylinder block, a piston 3 that is slidably disposed inside the cylinder 2, and a combustion chamber 4 that is formed between the piston 3 and a cylinder head. The piston 3 is coupled with a crankshaft 6 through a connecting rod 5, and the crankshaft 6 rotates as the piston 3 reciprocates along an inner wall of the cylinder 2.

An intake port 11 and an exhaust port 12 are provided on the cylinder head. The combustion chamber 4 communicates with an intake passage 13 through the intake port 11, and communicates with an exhaust passage 14 through the exhaust port 12. The intake port 11 is opened and closed by an intake valve 15, and the exhaust port 12 is opened and closed by an exhaust valve 16. A throttle valve 17 is provided in the intake passage 13 on an upstream side of the intake valve 15.

The throttle valve 17 includes, for example, a butterfly valve, and an intake air amount into the combustion chamber 4 is adjusted by the throttle valve 17. The throttle valve 17 is driven by a throttle actuator such as an electric motor according to an operation of an accelerator pedal. The intake valve 15 and the exhaust valve 16 are driven to be opened and closed at a predetermined timing synchronized with the rotation of the crankshaft 6 by a valve mechanism (not illustrated). The timing of opening and closing the valves 15 and 16 can be changed as appropriate.

An ignition plug 18 and a direct injection type of injector 19 are attached to either the cylinder head or the cylinder block (for example, the cylinder head) so as to face the combustion chamber 4 of the cylinder 2. The ignition plug 18 is disposed between the intake port 11 and the exhaust port 12, generates sparks by electric energy, and ignites an air-fuel mixture in the combustion chamber 4. The injector 19 is disposed in the vicinity of the intake valve 15 and is driven by electric energy to inject fuel obliquely downward into the combustion chamber 4. The arrangement of the injector 19 is not limited thereto, and the injector 19 may be disposed in the vicinity of the ignition plug 18. The injector 19 may be a port injection type that injects fuel into the intake port, instead of or in addition to the direct injection type.

An exhaust gas purification device 20 for purifying an exhaust gas is interposed in the exhaust passage 14. The exhaust gas purification device 20 is a three-way catalyst having a function of removing and purifying HC, CO, and NOx contained in the exhaust gas by an oxidation/reduction action. Other exhaust gas purification devices such as an oxidation catalyst for oxidizing CO and HC in the exhaust gas can also be used. When a temperature (catalyst temperature Tc) of the catalyst included in the exhaust gas purification device 20 increases, the catalyst is activated, and the purification action of the exhaust gas by the exhaust gas purification device 20 increases. However, when the catalyst temperature Tc becomes excessively high, the exhaust gas purification device 20 is damaged, so that the catalyst temperature Tc needs to be suppressed to a predetermined temperature (upper limit temperature T1) or less.

Further, the engine 1 further includes an exhaust gas recirculation device 25. The exhaust gas recirculation device 25 includes an EGR passage 26 and an EGR valve 27 disposed in the EGR passage 26. One end of the EGR passage 26 is connected to the downstream side of the exhaust gas purification device 20 in the exhaust passage 14, and the other end is connected to the upstream side of the throttle valve 17 in the intake passage 13. The exhaust gas flowing through the exhaust passage 14 can be recirculated to the intake passage 13 through the EGR passage 21 and the EGR valve 27. The EGR valve 27 is driven by an EGR actuator such as an electric motor, and is configured to be adjustable in opening degree. The exhaust gas recirculation device 25 can be omitted.

In such an engine 1, when an accelerator pedal is depressed, the throttle valve 17 is opened to increase an intake air amount. Accordingly, the exhaust temperature rises, and the catalyst temperature Tc rises accordingly. The engine 1 needs to be configured such that the catalyst temperature Tc does not exceed the upper limit temperature T1. In order to suppress the catalyst temperature Tc, it is conceivable to relatively increase a fuel injection amount from the injector 19 to make an air-fuel ratio rich. However, in this case, since the fuel injection amount increases, fuel consumption deteriorates and emission deteriorates. In this regard, in the present embodiment, the control apparatus for the internal combustion engine is configured to reduce the intake air amount below a target intake air amount according to the operation of the accelerator pedal, thereby suppressing the rise in the exhaust temperature and suppressing the catalyst temperature Tc to be equal to or lower than the upper limit temperature T1.

Meanwhile, it takes some time for the intake air having passed through the throttle valve 17 to reach the exhaust gas purification device 20. Therefore, when the accelerator pedal is depressed, the opening degree of the throttle valve 17 increases and the intake air amount increases, but the exhaust temperature does not rise immediately, and the rise in the catalyst temperature Tc is delayed. This is referred to as a response delay of the catalyst temperature Tc due to an intake delay. The response delay of the catalyst temperature Tc is caused by a delay depending on the lengths of an intake path and an exhaust path until the air reaches the exhaust gas purification device 20, a delay in heat transfer from the air to the catalyst, and the like. Therefore, when the catalyst temperature Tc is detected (or calculated) and the restriction on the intake air amount is started when the catalyst temperature Tc reaches a predetermined value (restriction start temperature), there is a risk that the catalyst temperature Tc overshoots due to the response delay and exceed the upper limit temperature T1.

In this regard, when the restriction start temperature is set low, an excessive rise in the catalyst temperature Tc can be suppressed even if there is a response delay. However, in this case, when the depression amount of the accelerator pedal is small and the rising speed of the exhaust temperature is slow, there is a risk that the intake air amount is restricted more than necessary, and the generation of torque is suppressed. In this regard, in the present embodiment, the control apparatus for the internal combustion engine is configured as follows so that the catalyst temperature Tc becomes equal to or lower than the upper limit temperature T1 while the intake air amount is optimally suppressed according to the operation state.

FIG. 2 is a block diagram illustrating a configuration of a main part of a control apparatus 100 for the internal combustion engine according to the present embodiment, and mainly illustrates a configuration related to control of the intake air amount. As illustrated in FIG. 2, the control apparatus 100 includes a controller 40 for engine control as a center, and includes an input part 31 connected to the controller 40, an intake air amount sensor 32, a rotational speed sensor 33, and an actuator 35.

The input part 31 outputs a signal for commanding a target torque of the engine 1. The input part 31 includes, for example, an accelerator opening sensor that detects an operation amount of an accelerator pedal. A torque command value is input to the controller 40 by the input part 31. The control apparatus for the internal combustion engine according to the present embodiment can also be applied to a vehicle having a driving support function or an automated driving vehicle, and in that case, a vehicle control system serves as the input part 31, and a torque command value is input to the controller 40.

The intake air amount sensor 32 is a sensor that detects an amount of intake air (mass flow rate). The intake air amount sensor 32 includes, for example, an air flow meter disposed in the intake passage 13 (more specifically, upstream of the throttle valve 17). The intake air amount corresponds to a physical amount having a correlation with the load of the engine 1. The load of the engine 1 is not limited to the intake air amount sensor 32, and can be calculated by using a detection value of an accelerator opening sensor (input part 31) or a pressure sensor that detects an intake air pressure downstream of the throttle valve 17.

The rotational speed sensor 33 is a sensor that detects the rotational speed of the engine 1, and includes, for example, a crank angle sensor provided in the vicinity of the crankshaft 6. The crank angle sensor is configured to output a pulse signal (crank signal) in accordance with the rotation of the crankshaft 6. That is, the crank signal is output every time the crankshaft rotates by a predetermined angle, and an engine speed can be detected based on the crank signal. The operation state of the engine 1, that is, the operating point can be identified mainly based on signals from the intake air amount sensor 32 and the rotational speed sensor 33.

The actuator 35 is a throttle actuator that adjusts the opening degree of the throttle valve 17. The actuator 35 is driven in accordance with the torque command value, and can control the intake air amount by adjusting a throttle opening degree through the driving of the actuator 35. That is, the intake air amount can be controlled to the target intake air amount according to the torque command value, or can be controlled to a restricted intake air amount which is more restricted than the target intake air amount. Regarding the control of the intake air amount, controlling the intake air amount to the target intake air amount according to the torque command value is referred to as normal intake control, and controlling the intake air amount to the restricted intake air amount which is more restricted than the target intake air amount is referred to as restricted intake control.

By guiding EGR gas to the intake passage through the exhaust gas recirculation device 25, the intake air amount (amount of fresh air) can also be restricted. In this case, the actuator 35 includes a throttle actuator and an EGR actuator.

The controller 40 includes an electronic control unit (ECU). More specifically, the controller 40 includes a computer including a CPU, a ROM, a RAM, and other peripheral circuits such as an I/O interface. The controller 40 outputs a control signal to the actuator 35 based on signals from the input part 31, the intake air amount sensor 32, and the rotational speed sensor 33.

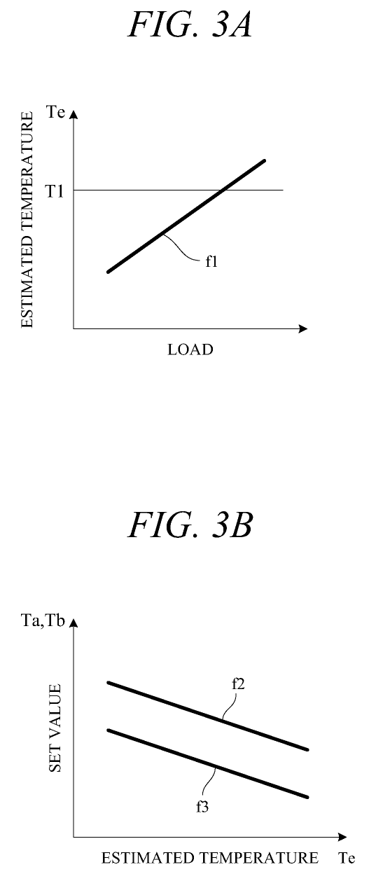

The controller 40 includes a temperature calculation unit 41, a temperature estimation unit 42, a setting unit 43, an output unit 44, and a storage unit 45 as a functional configuration. Various maps, threshold values, control programs, and the like are stored in advance in the storage unit 45. FIGS. 3A and 3B are diagrams illustrating an example of a map stored in the storage unit 45.

FIG. 3A is a diagram illustrating a relationship between a load acting on the engine 1 and an estimated value of the catalyst temperature Tc. The estimated value (estimated temperature Te) of the catalyst temperature Tc is a catalyst temperature Tc corresponding to a predetermined load estimated when it is assumed that the load continuously acts on the engine 1, and corresponds to a convergence value when the catalyst temperature Tc converges with the lapse of time. A characteristic f1 in FIG. 3A can be obtained by experiment or analysis in advance. As illustrated in FIG. 3A, the estimated temperature Te rises as the load increases. In a region where the load is equal to or more than a predetermined value, the estimated temperature Te is equal to or more than the upper limit temperature T1. As described above, the load corresponds to the throttle opening degree, the intake air amount, and the intake air pressure. Therefore, the characteristic f1 in FIG. 3A can be replaced with, for example, a relationship between the throttle opening degree (torque command value) and the estimated temperature Te. The estimated temperature Te can also be obtained by a calculation formula using a load as a parameter without using a map.

A characteristic f2 in FIG. 3B is a diagram illustrating a relationship between the estimated temperature Te and a set value Ta, and a characteristic f3 is a diagram illustrating a relationship between the estimated temperature Te and a set value Tb. The set value Ta is a set value of the catalyst temperature at which the restriction on the intake air (restricted intake control) is started, that is, a restriction start set value. The set value Tb is a set value of the catalyst temperature at which the restricted intake control is ended after the start of the restricted intake control, that is, a restriction end set value. The characteristics f2 and f3 in FIG. 3B can be obtained in advance by experiment or analysis. As illustrated in FIG. 3B, both the restriction start set value Ta and the restriction end set value Tb decrease as the estimated temperature Te rises.

The restriction end set value Tb is lower than the restriction start set value Ta. The rate of decrease in the restriction start set value Ta (the slope of the characteristic f2) with the increase in the estimated temperature Te is equal to the rate of decrease in the restriction end set value Tb (the slope of the characteristic f3). The rate of decrease in the restriction start set value Ta may be different from the rate of decrease in the restriction end set value Tb. The set values Ta and Tb can also be obtained by a calculation formula using the estimated temperature Te as a parameter without using a map.

The temperature calculation unit 41 calculates the catalyst temperature Tc according to the operation state of the engine 1. Specifically, based on the signals from the intake air amount sensor 32 and the rotational speed sensor 33, the temperature calculation unit 41 calculates the current catalyst temperature Tc by using a predetermined map or a calculation formula. As the intake air amount increases and the engine speed increases, the calculated catalyst temperature Tc rises. The temperature calculation unit 41 may set, as the catalyst temperature Tc, a value obtained by adding a predetermined margin to the calculated value of the catalyst temperature. That is, a value higher than the actual catalyst temperature by the predetermined margin may be set as the catalyst temperature Tc.

Instead of calculating the catalyst temperature Tc according to the intake air amount and the engine speed, the catalyst temperature Tc may be detected by a sensor. For example, the catalyst temperature Tc may be directly detected by a temperature sensor. The temperature calculation unit 41 may calculate the catalyst temperature based on a detection value obtained by detecting the temperature of another portion having a correlation with the catalyst temperature Tc. For example, the temperature of the combustion chamber 4 or the vicinity thereof may be detected by the temperature sensor, and the catalyst temperature Tc may be calculated based on the temperature of the combustion chamber 4. The exhaust temperature may be detected by the temperature sensor, and the catalyst temperature Tc may be calculated based on the exhaust temperature.

The temperature estimation unit 42 calculates the estimated temperature Te of the catalyst corresponding to the load of the engine 1 by using the characteristic f1 in FIG. 3A. Specifically, the temperature estimation unit 42 regards, as a load, the torque command value input by the input part 31, and calculates the estimated temperature Te according to the load. The load of the engine 1 may be detected by, for example, a pressure sensor that detects an intake air pressure downstream of the throttle valve 17, and the temperature estimation unit 42 may calculate the estimated temperature Te according to the detection value of the pressure sensor.

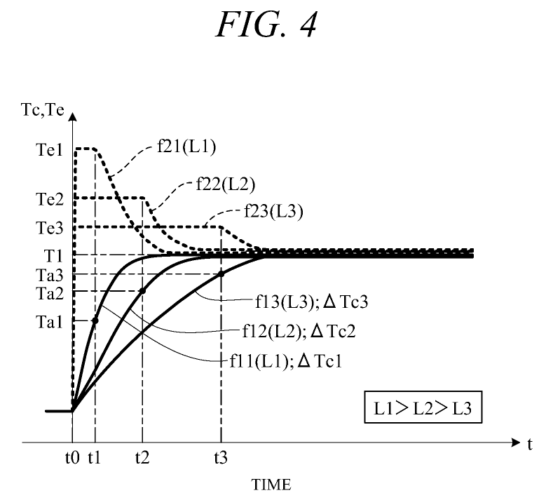

FIG. 4 is a time chart illustrating an example of changes of the catalyst temperature Tc and the estimated temperature Te with the lapse of time. A horizontal axis in FIG. 4 represents time point t0 when the accelerator pedal is depressed, that is, elapsed time “t” from the input of the torque increase command. The characteristics f11 to f13 indicated by solid lines in the drawing are characteristics indicating a change in the catalyst temperature Tc, and characteristics f21 to f23 indicated by dotted lines are characteristics indicating a change in the estimated temperature Te. The estimated temperature Te is an attainment temperature of the catalyst such as an attainment setting temperature or an attainment temperature set value.

The characteristics f11 and f21 are characteristics corresponding to a first load L1, the characteristics f12 and f22 are characteristics corresponding to a second load L2, and the characteristics f13 and f23 are characteristics corresponding to a third load L3. The first load L1 is larger than the second load L2, and the second load L2 is larger than the third load L3 (L1 > L2 > L3). The first load L1 may be referred to as a high load, the second load L2 may be referred to as a medium load, and the third load L3 may be referred to as a low load for distinction.

As illustrated in FIG. 4, when the accelerator pedal is depressed at time point t0, the estimated temperature Te estimated by the temperature estimation unit 42 rises. The estimated temperature Te increases as the load increases (FIG. 3A), and the estimated temperatures Te corresponding to the first load L1, the second load L2, and the third load L3 are Te1, Te2, and Te3, respectively. These estimated temperatures Te1, Te2, and Te3 have a relationship of Te1 > Te2 > Te3. In FIG. 4, the estimated temperatures Te1, Te2, and Te3 all decrease with the lapse of time since the intake air amount is restricted by the restricted intake control to be described later and the load decreases (FIG. 3A).

When the accelerator pedal is depressed at time point t0, the catalyst temperature Tc calculated by the temperature calculation unit 41 also rises. The rate of rise in the catalyst temperature Tc (temperature rise amount per unit time), that is, the slopes of the characteristics f11 to f13 increase as the load increases. When the rates of rise in the catalyst temperatures Tc1, Tc2, and Tc3 corresponding to the first load L1, the second load L2, and the third load L3 are denoted by ΔTc1, ΔTc2, and ΔTc3, there is a relationship of ΔTc1 > ΔTc2 > ΔTc3 among these ΔTc1, ΔTc2, and ΔTc3. However, the rate of rise in the catalyst temperature Tc is smaller than the rate of rise in the estimated temperature Te. Therefore, immediately after the accelerator pedal is depressed, the estimated temperature Te is higher than the catalyst temperature Tc.

The setting unit 43 in FIG. 2 sets a set value corresponding to the estimated temperature Te, that is, the restriction start set value Ta, based on the characteristic f2 in FIG. 3B. For example, when the estimated temperature Te is any one of the estimated temperature Te1, Te2, or Te3 in FIG. 4, the restriction start set value Ta1, Ta2, or Ta3 corresponding to the estimated temperature Te1, Te2, or Te3 is set. The restriction start set values Ta1, Ta2, and Ta3 have a relationship of Ta1 < Ta2 < Ta3, and the restriction start set value Ta decreases as the estimated temperature Te rises.

When the estimated temperature Te is constant, the setting unit 43 calculates the restriction start set value Ta as a constant value. Therefore, the restriction start set values Ta1, Ta2, and Ta3 are constant between time points t0 and t1, between time points t0 and t2, and between time points t0 and t3 in FIG. 4, respectively. When the estimated temperature Te decreases after time point t1, after t2, or after t3, the restriction start set value Ta (one-dot chain line) set by the setting unit 43 accordingly rises (FIG. 3B).

The output unit 44 determines a magnitude relationship between the catalyst temperature Tc calculated by the temperature calculation unit 41 and the restriction start set value Ta set by the setting unit 43. More specifically, the output unit 44 determines whether or not the catalyst temperature Tc is equal to or higher than the restriction start set value Ta. Then, a control signal is output to the throttle actuator 35 according to the determination result. For example, when Tc < Ta is determined, the output unit 44 controls the actuator 35 according to the torque command value input by the input part 31 (normal intake control). Accordingly, the throttle opening degree becomes a target throttle opening degree corresponding to the depression of the accelerator pedal, and the intake air amount becomes the target intake air amount corresponding to the torque command value.

On the other hand, when Tc ≥ Ta is determined, the output unit 44 restricts the throttle opening degree below target throttle opening degree (restricted intake control). Accordingly, an increase in the intake air amount can be suppressed, a rise in the catalyst temperature Tc can be suppressed, and the catalyst temperature Tc can be suppressed to the upper limit temperature T1 or less. The output unit 44 can limit the intake air amount in various modes in the restricted intake control. As an example, the output unit 44 controls the actuator 35 such that the intake air amount becomes a value obtained by multiplying the target intake air amount by the normal intake control by a predetermined coefficient less than 1. As another example, the output unit 44 may restrict the throttle opening degree to a predetermined opening regardless of the target intake air amount in the restricted intake control.

After the restricted intake control is started, the setting unit 43 sets a set value corresponding to the estimated temperature Te, that is, the restriction end set value Tb, based on the characteristicf3 in FIG. 3B. After the start of the restricted intake control, the output unit 44 determines a magnitude relationship between the catalyst temperature Tc calculated by the temperature calculation unit 41 and the restriction end set value Tb set by the setting unit 43. More specifically, the output unit 44 determines whether or not the catalyst temperature Tc is equal to or lower than the restriction end set value Tb. When Tc > Tb is determined, the output unit 44 continues the restriction on intake air by the restricted intake control. When Tc ≤ Tb is determined, the output unit 44 ends the restricted intake control and controls the actuator 35 according to the torque command value input by the input part 31 (normal intake control).

As described above, the controller 40 functions as an intake restriction part that restricts the intake air amount according to the catalyst temperature Tc, and a restriction release part that releases the restriction on the intake air amount according to the catalyst temperature Tc after starting the restriction on the intake air amount by the intake restriction part. The intake restriction part and the restriction release part can be configured by the setting unit 43 and the output unit 44.

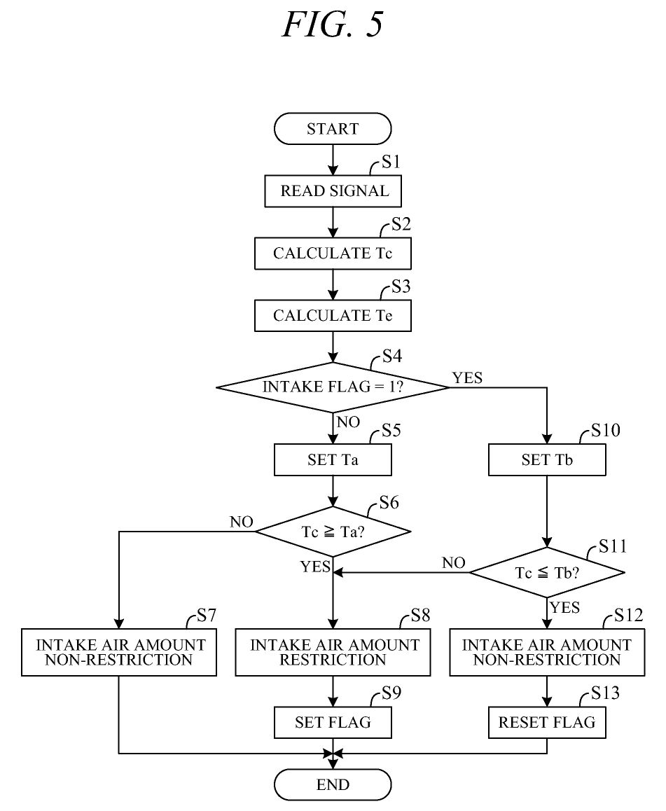

FIG. 5 is a flowchart illustrating an example of processing executed by the CPU of the controller 40 in FIG. 2, particularly, an example of processing related to the intake control (normal intake control, restricted intake control). The processing illustrated in the flowchart starts, for example, with turning on the engine switch, and repeats at predetermined cycles.

As illustrated in FIG. 5, the controller 40 first reads signals from the input part (for example, the accelerator opening sensor) 31, the intake air amount sensor 32, and the rotational speed sensor 33 in S1 (S: processing step). Next, in S2, based on the signals from the intake air amount sensor 32 and the rotational speed sensor 33, the controller 40 (temperature calculation unit 41) calculates the current catalyst temperature Tc by using a predetermined map or by a calculation formula. Next, in S3, the controller 40 (temperature estimation unit 42) calculates the estimated temperature Te corresponding to the load of the engine 1 by using the characteristic f1 in FIG. 3A. For example, the temperature estimation unit 42 regards, as a load, the torque command value input by the input part 31, and calculates the estimated temperature Te according to the torque command value.

Next, in S4, the controller 40 (setting unit 43) determines whether or not an intake flag is 1. The intake flag is 0 in an initial state, and is set to 1 when the intake restriction control is started. When a negative determination is made in S4, that is, when it is determined that the intake restriction control is not being performed, the process proceeds to S5. In S5, the controller 40 (setting unit 43) sets the restriction start set value Ta corresponding to the estimated temperature Te based on the characteristic f2 in FIG. 3B.

Next, in S6, the controller 40 (output unit 44) determines whether or not the catalyst temperature Tc calculated in S2 is equal to or higher than the restriction start set value Ta set in S5. When a negative determination is made in S6, the process proceeds to S7, and the controller 40 (output unit 44) outputs a control signal to the actuator 35 to control the throttle opening degree to the target throttle opening degree corresponding to the torque command value of the input part 31. In this case, the intake air amount is not restricted (intake air amount non-restriction).

On the other hand, when an affirmative determination is made in S6, the process proceeds to S8, and the controller 40 (output unit 44) outputs a control signal to the actuator 35 to restrict the throttle opening degree. Accordingly, the throttle opening degree becomes smaller than the target throttle opening degree, and the intake air amount is restricted (intake air amount restriction). Next, in S9, the controller 40 sets the intake flag to 1 and ends the process.

When it is determined in S4 that the intake flag is 1, the process proceeds to S10. In S10, the controller 40 (setting unit 43) sets the restriction end set value Tb corresponding to the estimated temperature Te based on the characteristic f3 in FIG. 3B. Next, in S11, the controller 40 (output unit 44) determines whether or not the catalyst temperature Tc is equal to or lower than the restriction end set value Tb. When a negative determination is made in S11, the process proceeds to S8, and the controller 40 (output unit 44) outputs a control signal to the actuator 35 to continue the throttle restriction (intake air amount restriction).

On the other hand, when an affirmative determination is made in S11, the process proceeds to S12, and the controller 40 (output unit 44) outputs a control signal to the actuator 35 to control the throttle opening degree to the target throttle opening degree corresponding to the torque command value of the input part 31 (intake air amount non-restriction) as in S7. Next, in S13, the controller 40 resets the intake flag to 0, and ends the process.

The main operation of the control apparatus 100 for the internal combustion engine according to the present embodiment will be described. For example, when the accelerator pedal is depressed to the maximum at time point t0 in FIG. 4, the first load L1 acts on the engine 1. At this time, the estimated temperature Te, which is an estimated value of the catalyst temperature Tc (Tc1), rapidly rises, and the estimated temperature Te1 corresponding to the first load L1 exceeds the upper limit temperature T1 (characteristic f21). At this time, the actual catalyst temperature Tc1 rises more gradually than the estimated temperature Te (characteristic f11).

Thereafter, at time point t1, when the catalyst temperature Tc1 attains the restriction start set value Ta1 corresponding to the estimated temperature Te1 of the first load L1, the throttle opening degree is restricted, whereby the intake air amount is restricted (S8). As a result, the estimated temperature Te gradually decreases (characteristic f21), and the rate ΔTc1 of rise in the catalyst temperature Tc1 becomes gradual (characteristic f11). Therefore, the catalyst temperature Tc1 does not overshoot or the degree of overshoot is small, and the catalyst temperature Tc1 approaches the upper limit temperature T1 with the lapse of time.

At time point t0, when the depression amount of the accelerator pedal is small, the load of the engine 1 becomes the second load L2 or the third load L3 smaller than the first load L1. Also in this case, the estimated temperature Te rapidly rises, but the estimated temperature Te2 corresponding to the second load L2 and the estimated temperature Te3 corresponding to the third load L3 are lower than the estimated temperature Te1 (characteristic f22, f23). Therefore, the restriction start set values Ta2 and Ta3 are higher than the restriction start set value Ta1, and the restriction on the throttle opening degree (intake air amount restriction) is started at time point t2 or t3 after time point t1 (S8).

Accordingly, the rate ΔTc2 of rise in the catalyst temperature Tc2 corresponding to the second load L2 becomes gradual after time point t2 (characteristic f12), and the rate ΔTc3 of rise in the catalyst temperature Tc3 corresponding to the third load L3 becomes gradual after time point t3 (characteristic f13). In this manner, when the second load L2 or the third load L3 acts on the engine 1, the timing of starting the intake air restriction is delayed as compared with when the first load L1 acts. However, the rates ΔTc2 and ΔTc3 of rise in the catalyst temperatures Tc2 and Tc3 before the start of the intake air restriction are smaller than the rate ΔTc1 of rise in the catalyst temperature Tc1 before the start of the intake air restriction. Therefore, the catalyst temperatures Tc2 and Tc3 do not overshoot, or the degree of overshoot is small, and the catalyst temperatures Tc2 and Tc3 approach the upper limit temperature T1 with the lapse of time.

As described above, in the present embodiment, the timing of starting the intake air restriction is delayed as the load acting on the engine 1 decreases. Accordingly, when the load increases due to depression of the accelerator pedal, the catalyst temperature Tc does not exceed the upper limit temperature T1, and a decrease in torque can be minimized.

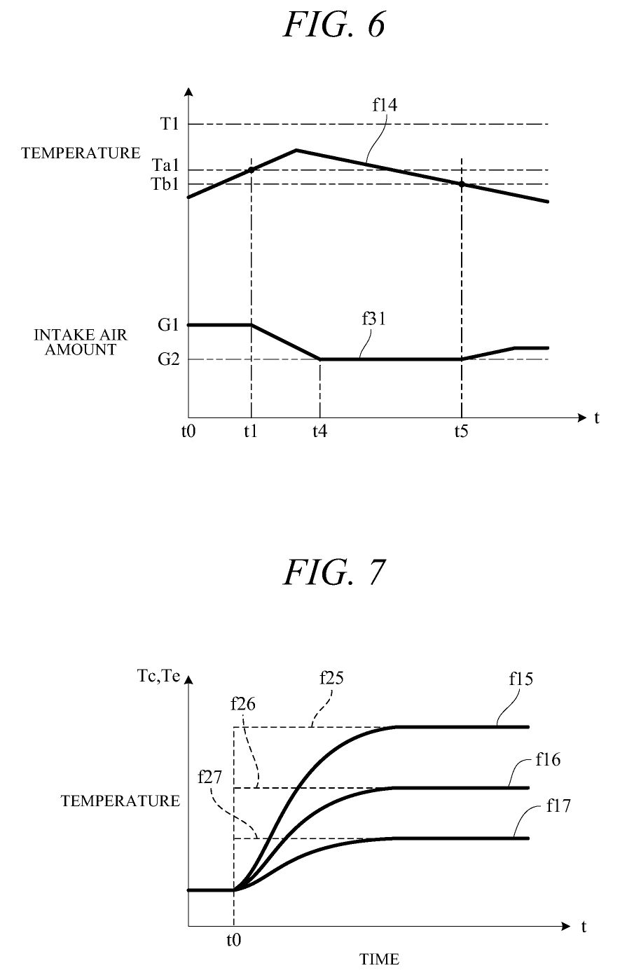

FIG. 6 is a time chart illustrating an example of changes in the catalyst temperature Tc and an intake air amount G after time point t0, and is, for example, a time chart corresponding to the first load L1. A characteristic f14 in the drawing indicates a change in the catalyst temperature Tc, and a characteristic f31 indicates a change in the intake air amount G. As illustrated in FIG. 6, when the accelerator pedal is depressed at time point t0, the catalyst temperature Tc (Tc1) gradually rises. At this time, the intake air amount G becomes a target intake air amount G1 according to the torque command value.

At time point t1, when the catalyst temperature Tc1 becomes equal to or higher than the restriction start set value Ta1, the throttle opening degree is restricted and the intake air amount decreases (S8). At this time, the controller 40 outputs a control signal to the actuator 35 to gradually reduce the throttle opening degree (time points t1 to t4). Accordingly, the intake air amount gradually decreases, and shock can be suppressed (characteristic f31). When the intake air amount is restricted, the catalyst temperature Tc1 gradually decreases (characteristic f14). Accordingly, it is possible to prevent the catalyst temperature Tc1 from attaining the upper limit temperature T1.

Thereafter, at time point t5, when the catalyst temperature Tc1 becomes equal to or lower than the restriction end temperature Tb1, the intake air restriction control is ended, and the throttle opening degree returns to the value before the restriction (S12). Accordingly, the intake air amount gradually increases. When the catalyst temperature Tc becomes equal to or lower than the restriction end set value Tb in this manner, the intake air restriction is released, so that the intake air restriction can be quickly released, and the decrease in torque can be minimized. In addition, since the restriction end set value Tb is set to a value lower than the restriction start set value Ta, it is possible to prevent the start and end of the intake air restriction from being frequently repeated when the catalyst temperature Tc changes.

According to the present embodiment, the following operations and effects are achievable.

(1) A control apparatus 100 for an internal combustion engine includes: a temperature calculation unit 41 that calculates a catalyst temperature Tc in an exhaust gas purification device 20 provided in an exhaust passage 14 of an engine 1; an actuator 35 for driving a throttle valve 17 that adjusts an intake air amount sucked into the engine 1; and a controller 40 that controls the actuator 35 according to a load (FIG. 2). The controller 40 includes an intake restriction part that restricts the intake air amount according to the catalyst temperature Tc calculated by the temperature calculation unit 41 (FIG. 4). The intake restriction part starts restriction on the intake air amount earlier as a degree of rise in the catalyst temperature Tc increases (FIG. 4). That is, when a rate of the rise in the catalyst temperature Tc is large (for example, characteristic f11), the intake restriction part starts an intake air restriction earlier than when the rate of the rise is small (for example, characteristic f13) (FIG. 4). Accordingly, a timing of starting the intake air restriction becomes variable, and decrease in torque can be minimized while suppressing the catalyst temperature Tc to an upper limit temperature T1 or less.

(2) The controller 40 (intake restriction part) calculates an attainment temperature of the catalyst temperature Tc corresponding to an operation state of the engine 1, that is, an estimated temperature Te, and starts the restriction on the intake air amount earlier as the estimated temperature Te rises (FIG. 4). Since the rate of the rise in the catalyst temperature Tc increases as the estimated temperature Te rises, by starting the restriction on the intake air amount earlier as the estimated temperature Te rises, it is possible to reliably prevent the catalyst temperature Tc from exceeding the upper limit temperature T1 due to a response delay of the catalyst temperature Tc caused by the delay of intake air.

(3) The controller 40 (intake restriction part) sets a restriction start set value Ta of the intake air amount to be lower as the estimated temperature Te rises, and starts the restriction on the intake air amount when the catalyst temperature Tc becomes equal to or higher than the restriction start set value Ta (FIG. 5). Accordingly, the restriction on the intake air amount can be started earlier as the estimated temperature Te rises.

(4) The controller 40 further includes a restriction release part that releases the restriction on the intake air amount according to the catalyst temperature Tc after starting the restriction on the intake air amount (FIG. 5). The restriction release part sets a restriction end set value Tb of the intake air amount to be higher as the estimated temperature Te decreases, and releases the restriction on the intake air amount when the catalyst temperature Tc becomes equal to or lower than the restriction end set value Tb (FIG. 3B, 5). Accordingly, the intake air restriction can be ended early, and the decrease in torque can be minimized.

(5) The controller 40 (restriction release part) sets the restriction end set value Tb to a value lower than the restriction start set value Ta (FIG. 3B). Accordingly, when the catalyst temperature Tc changes, it is possible to prevent the start and end of the intake air restriction from being frequently repeated.

In the above embodiment, the temperature calculation unit 41 calculates the catalyst temperature Tc based on the signals from the intake air amount sensor 32 and the rotational speed sensor 33, but the estimated temperature Te and the catalyst temperature Tc have a correlation (FIG. 4). Therefore, the catalyst temperature Tc may be calculated based on the estimated temperature Te. FIG. 7 is a diagram illustrating an example of calculating the catalyst temperature Tc based on the estimated temperature Te. In the drawing, a horizontal axis represents time (elapsed time from time point t0 when the accelerator pedal is depressed), and a vertical axis represents characteristics f25 to f27 (dotted line) of change in the estimated temperature Te and characteristics f15 to f17 (solid line) of change in the catalyst temperature Tc. The characteristics f25 and f15 correspond to the first load L1, the characteristics f26 and f16 correspond to the second load L2, and the characteristics f27 and f17 correspond to the third load L3.

As illustrated in FIG. 7, when the catalyst temperature Tc rises, the temperature calculation unit 41 calculates the catalyst temperature Tc by performing smoothing processing, based on the estimated temperature Te, such that the catalyst temperature Tc gradually increases with the lapse of time. More specifically, the temperature calculation unit 41 performs the smoothing processing such that the rate (slope) of rise in the catalyst temperature Tc increases as the estimated temperature Te is higher. Although not illustrated, the temperature calculation unit 41 performs the same smoothing processing not only when the catalyst temperature Tc rises but also when the catalyst temperature Tc decreases, to calculate the catalyst temperature Tc. More specifically, the temperature calculation unit 41 performs the smoothing processing such that the rate (slope) of decrease in the catalyst temperature Tc increases as the estimated temperature Te is lower.

As described above, the temperature calculation unit 41 calculates the catalyst temperature Tc by performing the smoothing processing, based on the estimated temperature Te, such that, during the rise of the catalyst temperature Tc, the catalyst temperature Tc rises more rapidly as the estimated temperature Te is higher, and during the decrease of the catalyst temperature Tc, the catalyst temperature Tc decreases more rapidly as the estimated temperature Te is lower (FIG. 7). Accordingly, the catalyst temperature Tc can be accurately calculated according to the estimated temperature Te.

The above embodiment can be modified to various forms. Hereinafter, modified examples will be described. In the above embodiment, the temperature calculation unit 41 acquires information on the catalyst temperature Tc, but it is also possible to detect the catalyst temperature Tc with a sensor and acquire the information, and the configuration of a temperature acquiring unit is not limited to the above. In the above embodiment, the intake air amount is adjusted by driving the throttle actuator 35, but it is also possible to adjust the intake air amount by driving the EGR valve 27, and by controlling the driving of the intake valve 15, the intake air amount can also be adjusted. Therefore, the configuration of an intake adjustment part is not limited to the above.

In the above embodiment, the controller 40, as a control unit, controls the actuator 35 according to the load. Specifically, the controller 40 calculates the estimated temperature Te (attainment temperature) as the temperature reached by the catalyst temperature Tc, and the higher the estimated temperature Te, the lower the restriction start set value T of the intake air amount (limitation start temperature) is set. However, as long as the restriction on the intake air amount is to start earlier as the estimated temperature Te is higher, then the processing of an intake restriction part may be of any processing. If the restriction on the intake air amount is to be started earlier as a degree of increase in the catalyst temperature Tc is greater, the intake restriction part may perform an intake restriction without using the estimated temperature. For example, the degree of increase in the catalyst temperature Tc (increase in the catalyst temperature Tc per unit time) may be detected by a sensor or calculated using a formula, and the intake restriction may be started based on this.

The above embodiment can be combined as desired with one or more of the above modifications. The modifications can also be combined with one another.

According to the present invention, an exhaust gas purification device can be well protected when a catalyst temperature rises.

Above, while the present invention has been described with reference to the preferred embodiments thereof, it will be understood, by those skilled in the art, that various changes and modifications may be made thereto without departing from the scope of the appended claims.

What is claimed is:

1. A control apparatus for an internal combustion engine comprising:
an intake adjustment part configured to adjust an intake air amount sucked into the internal combustion engine; and
an electronic control unit including a microprocessor and a memory connected to the microprocessor, wherein
the microprocessor is configured to perform
acquiring information on a catalyst temperature in an exhaust gas purification device provided in an exhaust passage of the internal combustion engine, and
controlling the intake adjustment part in accordance with a load,
the controlling including restricting the intake air amount in accordance with the catalyst temperature so as to start a restriction on the intake air amount earlier as a degree of increase in the catalyst temperature becomes greater.

2. The control apparatus according to claim 1, wherein
the microprocessor is configured to further perform
estimating an attainment temperature of the catalyst temperature estimated to be reached in accordance with an operation state of the internal combustion engine, and
the controlling including restricting the intake air amount so as to start the restriction on the intake air amount earlier as the attainment temperature is higher.

3. The control apparatus according to claim 2, wherein
the microprocessor is configured to perform
setting a restriction start temperature of the intake air amount lower as the attainment temperature of the catalyst temperature is higher, and
the controlling including starting the restriction on the intake air amount when the catalyst temperature becomes equal to or higher than the restriction start temperature.

4. The control apparatus according to claim 2, wherein
the microprocessor is configured to perform
the acquiring including calculating the catalyst temperature by performing a smoothing processing in which the catalyst temperature rises more rapidly as the attainment temperature becomes higher when the catalyst temperature is rising, and the catalyst temperature falls more rapidly as the attainment temperature becomes lower when the catalyst temperature is falling.

5. The control apparatus according to claim 2, further comprising
a torque detection part configured to detect a torque command value, wherein
the microprocessor is configured to perform
the estimating including estimating the attainment temperature in accordance with the torque command value detected by the torque detection part.

6. The control apparatus according to claim 3, wherein
the microprocessor is configured to perform
the controlling including releasing the restriction on the intake air amount in accordance with the catalyst temperature after the restriction on the intake air amount has started,
the setting including further setting a restriction end temperature of the intake air amount higher as the attainment temperature of the catalyst temperature is lower, and
the controlling including further releasing the restriction on the intake air amount when the catalyst temperature becomes equal to or lower than the restriction end temperature.

7. The control apparatus according to claim 6, wherein
the microprocessor is configured to perform
the setting including setting the restriction end temperature lower than the restriction start temperature.

8. The control apparatus according to claim 1, further comprising:
an intake air amount sensor detecting the intake air amount sucked into the internal combustion engine; and
a rotational speed sensor detecting a rotational speed of the internal combustion engine, wherein
the microprocessor is configured to perform
the acquiring including calculating the catalyst temperature based on the intake air amount detected by the intake air amount sensor and the rotational speed detected by the rotational speed sensor.

9. A control method for an internal combustion engine comprising:
acquiring information on a catalyst temperature in an exhaust gas purification device provided in an exhaust passage of the internal combustion engine;
adjusting an intake air amount sucked into the internal combustion engine; and
controlling the intake air amount in accordance with a load, wherein
the controlling includes restricting the intake air amount in accordance with the catalyst temperature so as to start a restriction on the intake air amount earlier as a degree of increase in the catalyst temperature becomes greater.
